(19) United States
(12) Patent Application Publication
(10) Pub. No.: US 2020/0393573 A1
(43) Pub. Date: Dec. 17, 2020

(54) CONTROL APPARATUS, METHOD AND COMPUTER PROGRAM CODE FOR CONTROLLING INDOOR POSITIONING TRANSITIONS

(71) Applicant: INDOORATLAS OY, Oulu (FI)

(72) Inventors: Arno SOLIN, Oulu (FI); Jukka RAANAMO, Oulu (FI); Juha ALA-LUHTALA, Oulu (FI); Otto SEISKARI, Oulu (FI); Ville TOLVANEN, Oulu (FI)

(73) Assignee: INDOORATLAS OY, Oulu (FI)

(21) Appl. No.: 16/971,092

(22) PCT Filed: Feb. 19, 2018
(86) PCT No.: PCT/FI2018/050119

§ 371 Date: Aug. 19, 2020

(51) Int. Cl. G01S 19/48; G01C 21/20

(52) U.S. Cl. CPC G01S 19/48; G01C 21/206

(57) ABSTRACT

A control apparatus, method and computer program code for controlling indoor positioning transitions. In response to detecting that a mobile apparatus is in an unmapped location, commanding the mobile apparatus to suspend generation of sensor data for indoor positioning with one or more sensors of the mobile apparatus. In response to an invoke mechanism, checking whether the mobile apparatus is likely to enter an indoor location for which indoor signal map data exists. If (YES) the checking indicates that the mobile apparatus is likely to enter the indoor location, commanding the mobile apparatus to start generating the sensor data for the indoor positioning with the one or more sensors, or else (NO) commanding the mobile apparatus to resume the suspension, and, in response to the invoke mechanism, performing the checking again.

### FIELD

The invention relates to a control apparatus for controlling indoor positioning transitions, a computer-implemented method for controlling indoor positioning transitions, and a computer-readable medium comprising computer program code.

### BACKGROUND

Mobile apparatuses are used for numerous applications in daily life. One important application is positioning. Besides outdoor positioning, indoor positioning is becoming common. Consequently, it is desirable to enhance functionality of the indoor positioning. Initialization of the indoor positioning should be fast so that the user experience is good, but power consumption of the mobile apparatus should be kept as low as possible.

### BRIEF DESCRIPTION

The present invention seeks to provide an improved control apparatus for controlling indoor positioning transitions, an improved computer-implemented method for controlling indoor positioning transitions, and improved computer program code for a control apparatus.

According to an aspect of the present invention, there is provided an apparatus as specified in claim 1.

According to another aspect of the present invention, there is provided a method as specified in claim 16.

According to another aspect of the present invention, there is provided a computer-readable medium comprising computer program code as specified in claim 17.

### LIST OF DRAWINGS

Example embodiments of the present invention are described below, by way of example only, with reference to the accompanying drawings, in which

FIGS. 1, 2 and 3 illustrate example embodiments of a control apparatus;

FIGS. 4 and 5 are state diagrams illustrating example operating logic embodiments of the control apparatus; and

FIGS. 6 and 7 illustrate indoor positioning example embodiments in relation to indoor signal map data.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments of apparatuses, they are simplified block diagrams that only show some structures and functional entities. The connections shown in these Figures are logical connections; the actual physical connections may be different. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses may also comprise other functions and structures. It should be appreciated that details of some functions, structures, and the protocols used for communication are irrelevant to the actual invention. Therefore, they need not be discussed in more detail here.

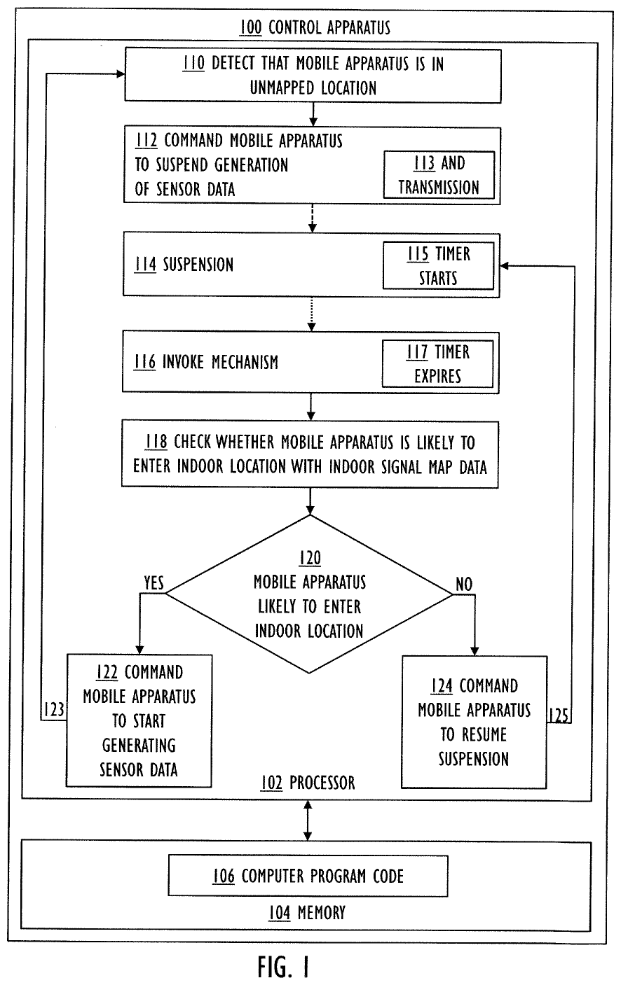

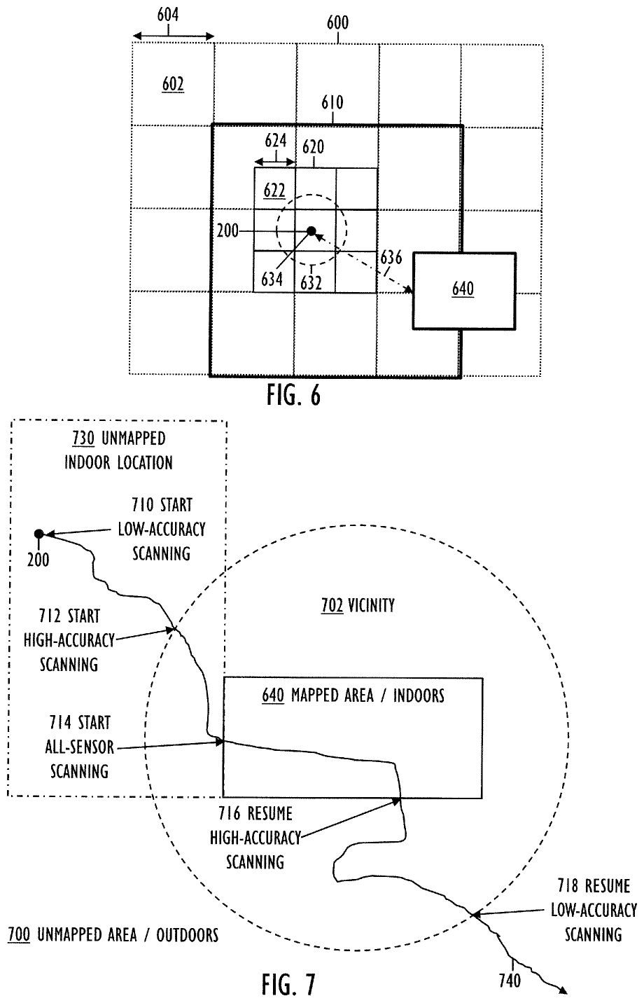

FIGS. 1, 2 and 3 illustrate example embodiments of a control apparatus 100, and FIGS. 6 and 7 illustrate indoor positioning in relation to indoor signal map data.

The control apparatus 100 comprises one or more processors 102, and one or more memories 104 storing computer program code 106.

The term ‘processor’ 102 refers to a device that is capable of processing data. Depending on the processing power needed, the control apparatus 100 may comprise several processors 102 such as parallel processors or a multicore processor. When designing the implementation of the processor 102, a person skilled in the art will consider the requirements set for the size and power consumption of the control apparatus 100, the necessary processing capacity, production costs, and production volumes, for example. The processor 102 and the memory 104 may be implemented by an electronic circuitry.

The term ‘memory’ 104 refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

The computer program code 106 may be implemented by software and/or hardware. In an example embodiment, the software may be written by a suitable programming language, and the resulting executable code 106 may be stored on the memory 104 and run by the processor 102. In an alternative example embodiment, the functionality of the hardware may be designed by a suitable hardware description language (such as Verilog or VHDL), and transformed into a gate-level netlist (describing standard cells and the electrical connections between them), and after further phases the chip implementing the processor 102, memory 104 and the code 106 of the control apparatus 100 may be fabricated with photo masks describing the circuitry.

The computer program code 106, when executed by the one or more processors 102, causes the control apparatus 100 at least to perform the following operations:

In response to detecting 110 that a mobile apparatus 200 is in an unmapped location, commanding 112 the mobile apparatus 200 to suspend 114 generation of sensor data for indoor positioning with one or more sensors 226 of the mobile apparatus 200.

In response to an invoke mechanism 116, checking 118 whether the mobile apparatus 200 is likely to enter an indoor location 640 for which indoor signal map data 258 exists.

If (YES branch in FIG. 1) the checking 118 indicates that the mobile apparatus 200 is likely to enter the indoor location 640, commanding 122 the mobile apparatus 200 to start generating the sensor data for the indoor positioning with the one or more sensors 226, or else (NO branch in FIG. 1) commanding 124 the mobile apparatus 200 to resume the suspension 114, and, in response to the invoke mechanism 116, performing the checking 118 again.

The described sequence of the operations 110-112-114-116-118-120-122/124 implements a computer-implemented method for controlling indoor positioning transitions. The operations are not strictly in chronological order in FIG. 1, and some of the operations may be performed simultaneously or in an order differing from the given ones. Other functions may also be executed between the operations or within the operations and other data exchanged between the operations. Some of the operations or part of the operations may also be left out or replaced by a corresponding operation or part of the operation. It should be noted that no special order of operations is required, except where necessary due to the logical requirements for the processing order.

Note that there are two loops 123, 125 in FIG. 1:

1) if the mobile apparatus 200 is likely to enter the indoor location 640 for which the indoor signal map data 258 exists, the operation 122 is performed and the loop 123 returns back to the operation 110, immediately after the operation 122 or after a predetermined delay, for example; and

2) else as the mobile apparatus 200 is not likely to enter the indoor location 640 for which the indoor signal map data 258 exists, the operation 124 is performed and the loop 125 returns back to the operation 114.

In an example embodiment, the unmapped location is an indoor location with missing indoor signal map data 258 or an outdoor location. Consequently, the control apparatus 100 for controlling indoor positioning transitions is capable of controlling at least the following transitions:
if the mobile apparatus 200 is first in an outdoor location 700, and then the mobile apparatus 200 enters the indoor location 640 with the indoor signal map data 258;
if the mobile apparatus 200 is first in the indoor location 640 with the indoor signal map data 258, and then the mobile apparatus 200 exits the indoor location 640 and enters the outdoor location 700;
if the mobile apparatus 200 is first in an indoor location 730 with missing indoor signal map data 258, and then the mobile apparatus 200 enters the indoor location 640 with the indoor signal map data 258; or
if the mobile apparatus 200 is first in the indoor location 640 with the indoor signal map data 258, and then the mobile apparatus 200 exits the indoor location 640 and enters the indoor location 730 with missing indoor signal map data 258.

Note that the transitions may occur between:
outdoor location <-> mapped indoor location; or
unmapped indoor location <-> mapped indoor location.

In an example embodiment, the suspension 114 of the generation of the sensor data for the indoor positioning with the one more sensors 226 reduces power consumption of the mobile apparatus 200. This is very useful, as a battery 228 (or other independent power source) of the mobile apparatus 200 is a scarce resource that should be used sparingly, and this is achieved by turning of the one or more sensors 226 during the suspension 114. During the suspension 114, the one or more sensors 226 may hibernate.

In an example embodiment, the invoke mechanism 116 comprises a timer starting 115 when the suspension 114 is commanded 112, and after the timer expires 117, the checking 118 is performed, and if the suspension 114 is resumed, the timer is restarted 115. The advantage of using such a timer mechanism 115, 117 is that it uses very little power of the mobile apparatus 200 while implementing the described control with the suspension 114 and invoke 116 mechanisms. In an example embodiment, the timer has a fixed running time. The fixed running time may be 30 seconds, for example, or some other relatively short time period, depending on the planned usage scenarios. In an example embodiment, the timer has an adjustable running time. For example: if the user of the mobile apparatus 200 stays in a densely populated city centre, the timer running time may be set relatively short, whereas if the user of the mobile apparatus 200 travels in a rural area, the timer running time may be set relatively long. The short running time may be 30 seconds, and the long running time may be five to ten minutes, for example. Depending on the application, the timer running time may be adjusted dynamically, or it may have a fixed value as explained.

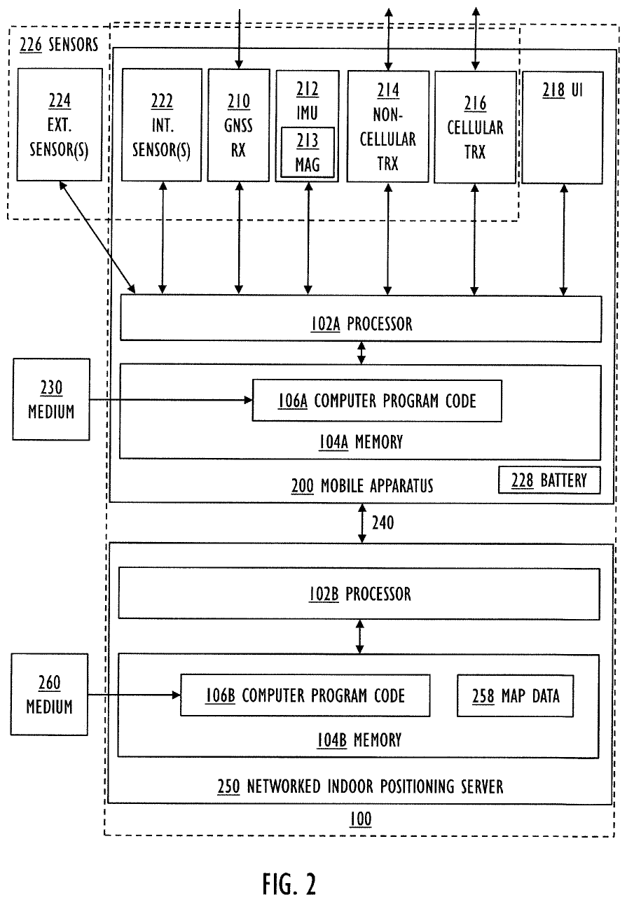

As shown in FIG. 2, the mobile apparatus 200 comprises the control apparatus 100, or a networked indoor positioning server 250 comprises the control apparatus 100, or functionality of the control apparatus 100 is divided between the mobile apparatus 200 and the networked indoor positioning server 250.

In an example embodiment, the mobile apparatus 200 and the networked indoor positioning server 250 are communicatively couplable 240 with each other. This means that the functionality of the control apparatus 100 may be centralized in one apparatus, such as in the mobile apparatus 200 or in the networked indoor positioning server 250, or distributed between the two 200, 250.

In an example embodiment, the mobile apparatus 200 is a portable electronic communication apparatus. A non-exhaustive list of the types of the mobile apparatus 200 includes: a mobile phone, a smartphone, a tablet computer, a phablet, a smartwatch, smartglasses, a general-purpose mobile computing device, etc. In an example embodiment, the mobile apparatus 200 is a general-purpose off-the-shelf computing device, as opposed to a purpose-build proprietary equipment, whereby research & development costs will be lower as only the special-purpose software (and not the hardware) needs to be designed, implemented and tested.

Also such example embodiment is feasible, wherein the mobile apparatus 200 is a part of or is fixed to another type of apparatus capable of moving around, such as a trolley, a mining vehicle, a robot, an automated guided vehicle, a submersible etc.

In an example embodiment, the networked indoor positioning server 250 may be implemented as a single server computer or as a cluster of computers. The server is a part of the client-server computing model that acts as distributed application which partitions tasks or workloads between the provider of a resource or service, called server, and the service requester, called client. The server 250 may serve a number of mobile apparatuses 200. The server computer 250 may be a host that is running one or more server programs which share their resources with clients 200. The client 200 may request a service function relating to the magnetic positioning from the server 250. Also, the client 200 may initiate a communication session with the server 250 which awaits incoming requests.

In an example embodiment, the networked indoor positioning server 250 may also operate according to the cloud computing model, at least in part. Naturally, besides these example embodiments of the networked indoor positioning server 250, other feasible computing architectures may be utilized as well to implement the hardware and software of the networked indoor positioning server 250. Consequently, besides operating according to the client/server architecture, push technology may be utilized as well. In push technology, the request for a transaction is initiated by networked indoor positioning server 250, whereas with the pull technology the request for the information is initiated by the client 200.

In an example embodiment, illustrated in FIG. 2, the networked indoor positioning server 250 may be accessible through a communication network 240. In an example embodiment, the communication network 240 comprises at least one of a wireless local area network base station, an indoor base station, an access point, a wireless hot-spot, all of which may provide Internet access of the networked indoor positioning server 250 through the use of a router connected to a link to an Internet service provider. In an example embodiment, the communication network 240 comprises a wireless standard/non-standard/proprietary cellular communication network such as any mobile phone network. In an example embodiment, the communication network 240 comprises a wired standard/non-standard/proprietary connection (such as Ethernet or USB), whereby the mobile apparatus 200 may sporadically, be coupled in a wired fashion with the communication network 240, and possibly also with the networked indoor positioning server 250.

In an example embodiment, the wireless communication network 240 comprises any mobile phone network, regardless of the generation (such as 2G, 3G, 4G, beyond 4G, 5G etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), Mobile WiMAX, and other radio systems (in their present forms and/or in their evolution forms).

In an example embodiment, the communication network 240 supports the use of subscriber identity module (SIM), which may be an integrated circuit storing subscriber data, which is network-specific information used to authenticate and identify the subscriber on the cellular network. The subscriber+identity module may be embedded into a removable SIM card. Consequently, the mobile apparatus 200 may include the SIM card (and a SIM card reader). Alternatively, the mobile apparatus 200 may include a virtual or software SIM card.

In an example embodiment, the mobile apparatus 200 comprises a user interface 218 implementing the exchange of graphical, textual and/or auditory information with the user. The user interface 218 may be realized with various techniques, such as a display (a multi-touch display, for example), means for producing sound, a keyboard, and/or a keypad, for example. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, or alternatively, the user interface 218 may comprise other user interface components, for example various means for focusing a cursor (mouse, track ball, arrow keys, touch sensitive area etc.) or elements enabling audio control.

In an example embodiment, the mobile apparatus 200 comprises a GNSS (Global Navigation Satellite System) receiver 210, which generates positioning data based on signals received from Earth-orbiting satellites. The GNSS may be GPS (Global Positioning System), Galileo, GLONASS, etc.

In an example embodiment, the mobile apparatus 200 comprises an inertial measurement unit 212, which comprises a magnetometer 213 to measure (possibly three-dimensional) variations in the magnetic field caused by building structures (especially by steel frames and steel-reinforced concrete). Furthermore, the inertial measurement unit 212 may comprise an acceleration sensor (measuring in one, two or three dimensions) and/or a gyroscope, for example.

In an example embodiment, the mobile apparatus 200 comprises a cellular radio transceiver 216 and/or a non-cellular radio transceiver 214.

In an example embodiment, the cellular radio transceiver 216 may be interoperable with the already-mentioned various wireless standard/non-standard/proprietary cellular communication network 240.

In an example embodiment, the non-cellular radio transceiver 214 may utilize a short-range radio transceiver such as a Bluetooth, Bluetooth low energy (BLE), Wi-Fi (or WiFi) or other WLAN (Wireless Local Area Network) transceiver (based on IEEE (Institute of Electrical and Electronics Engineers) 802.11 standard or its evolution versions (IEEE 802.11ac etc.), for example).

Naturally, the mobile apparatus 200 may include various other parts, such as a camera, or a radio-frequency identifier reader etc. Similarly, the networked indoor positioning server 250 may comprise, besides those described in FIG. 2, other parts and functionalities.

In an example embodiment, the one or more sensors 226 of the mobile apparatus 200 comprise sensors, which are communicatively coupled with the mobile apparatus 200. As shown in FIG. 2, the one more sensors 226 may comprise the already mentioned GNSS receiver 210, inertial measurement unit 212, non-cellular transceiver 214, and cellular transceiver 216, but also other internal sensors 222 and/or external sensors 224 (communicatively couplable with the mobile apparatus 200).

The other internal/external sensors 222, 224 may be for example:
A short range wireless reader configured to read the measurement data from a tag attached fixedly to a known location. The short range wireless radio reader may operate utilizing electric and/or magnetic fields, such as radio frequency identification (RFID) or near-field communication (NFC), for example.
A camera, and the measurement data ay be obtained by photographing a machine readable code (such as a barcode or a QR code) attached fixedly to a known location or by photographing or recording video (from a floor, walls and/or ceiling) and identifying the location from identified unique features.
A depth camera (possibly with infrared technology) as the information source, and the resulting three-dimensional images may be utilized in the location determination.

In an example embodiment, the one or more sensors 226 may generate as the sensor data for the indoor positioning at least one of the following types of the measurement data: inertial sensor data, magnetometer data, indoor base station data, cellular network data, wireless access point data, WiFi data, Bluetooth radio data, air pressure data, illumination data, audio data, video data, camera data, temperature data, barometer data, altitude data, range sensor data, indoor positioning data, global navigation satellite system data, smell sensor data, air quality sensor data, radar data, data generated by the internal sensor 222 of the mobile apparatus 200, data generated by the sensor 224 external to the mobile apparatus 200.

In an example embodiment, the processor 102, 102A, 102B may be implemented as a microprocessor implementing functions of a central processing unit (CPU) on an integrated circuit. The CPU is a logic machine executing the computer program code 106, 106A, 106B. The computer program code 106, 106A, 106B may be coded as a computer program using a programming language, which may be a high-level programming language, such as C, C++, or Java, or a low-level programming language, such as a machine language, or an assembler, for example. The microprocessor 102, 102A, 102B may also have an operating system (a dedicated operating system of an embedded system, a real-time operating system, or even a general-purpose operating system), which may provide the computer program code 106, 106A, 106B with system services.

A non-exhaustive list of implementation techniques for the processor 102, 102A, 102B and the memory 104, 104A, 104B includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

An example embodiment provides a computer-readable medium 230, 260 comprising the computer program code 106, 106A, 106B which, when loaded into the control apparatus 100 and executed by the control apparatus 100 causes the control apparatus 100 to perform the above-described computer-implemented method for controlling the indoor positioning transitions.

The example embodiments of the control apparatus 100 may be used to enhance the operation of the computer program code 106, 106A, 106B. There are many ways to structure the computer program code 106, 106A, 106B. In an example embodiment, the operations of the computer program code 106, 106A, 106B may be divided into functional modules, sub-routines, methods, classes, objects, applets, macros, etc., depending on the software design methodology and the programming language used. In modern programming environments, there are software libraries, i.e. compilations of ready-made functions, which may be utilized by the computer program code 106, 106A, 106B for performing a wide variety of standard operations. In an example embodiment, the computer program code 106, 106A, 106B may be in source code form, object code form, executable file, or in some intermediate form. The computer-readable medium 230, 260 may comprise at least the following: any entity or device capable of carrying computer program code 106, 106A, 106B to the control apparatus 100, a record medium, a computer memory, a read-only memory, an electrical carrier signal, a telecommunications signal, and a software distribution medium. In some jurisdictions, depending on the legislation and the patent practice, the computer-readable medium 230, 260 may not be the telecommunications signal. In an example embodiment, the computer-readable medium 230, 260 may be a non-transitory computer-readable storage medium.

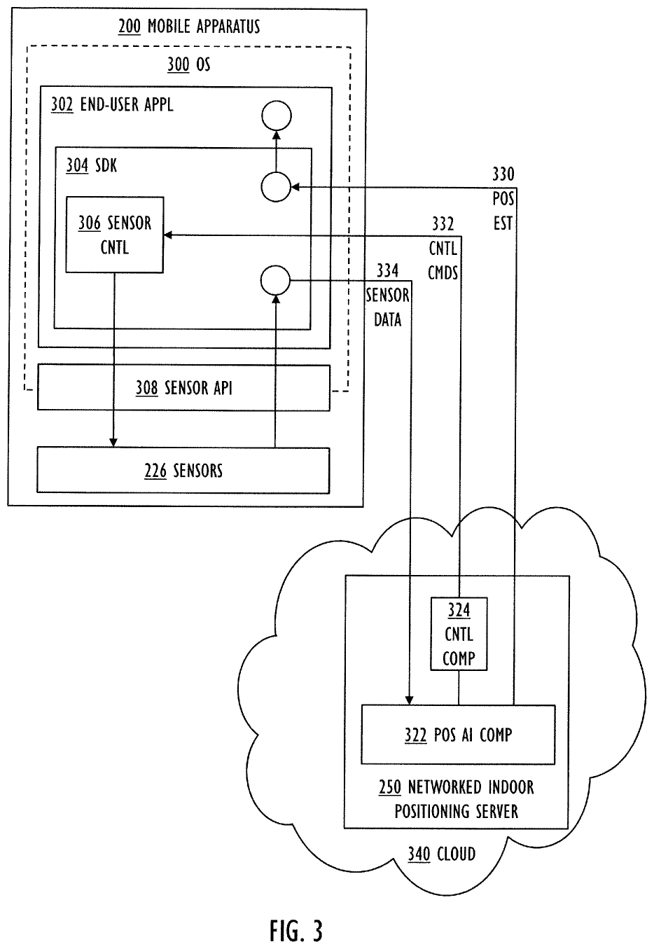

FIG. 3 illustrates an example embodiment of the software structure of the control apparatus 100 divided between the mobile apparatus 200 and the networked indoor positioning server 250 operating in a positioning cloud 340.

The mobile apparatus 200 comprises the operating system 300, whose services an end user application 302 utilizes. The end user application 302 utilizes a software development kit (SDK) 304, which provides access to a sensor controller software 306, which communicates with the one or more sensors 226 through a sensor application programming interface (API) 308.

The networked indoor positioning server 250 comprises a positioning artificial intelligence (AI) component 322, which receives sensor data 334 for the indoor positioning from the mobile apparatus 200, and based on the sensor data for the indoor positioning provides position estimates 330 to the mobile apparatus 200. Furthermore, the networked indoor positioning server 250 comprises a controller component 324, which provides the control commands 332 (relating to the suspension 114 and the invoke mechanism 116, for example) to the mobile apparatus 200.

The Applicant, IndoorAtlas, has developed many improvements for the magnetic positioning utilizing the measurements of magnetic field, disclosed in its various patents/applications, incorporated herein by reference in those jurisdictions where applicable: U.S. Pat. Nos. 8,798,924, 9,078,104, 9,080,874, 9,151,621, 9,154,914, 9,253,601, 9,316,501, 9,476,717, 9,521,522, 9,544,730 9,599,473, 9,674,672, 9,683,851, Ser. Nos. 13/871,612, 13/905,655, 13/915,016, 14/054,264, 14/093,250, 14/207,916, 14/725,521, 14/837,678, 14/859,985, and 15/074,085.

Steel structures (such as steel-frames or steel-reinforced concrete, for example) cause magnetic interferences indoors such as in buildings mines, subways, train stations, airports, harbours, particle accelerators, and other structures above ground or underground. The disturbances inside are consistent, creating a magnetic fingerprint unique to a specific location. The sensor data for the indoor positioning may thus comprise successive measurement samples of magnetic field disturbed by man-made or man-formed structures (or even natural structures such as an ore containing metal in a mine). The measured magnetic field may be the Earth's magnetic field disturbed by the various structures, or even, in some cases, a powerful magnetic field created by the various structures. The magnetic field measurements may be made by magnetometer 213.

Now that we have described the general operation environment, let us explain further example embodiments.

With reference to FIG. 6, let us consider various ways of detecting that the mobile apparatus 200 is likely to the enter the indoor location 640 for which the indoor signal map data 258 exists. Basically, there are two ways: the determined distance between the mobile apparatus 200 and the indoor location 640 may be estimated spatially or temporally, and the determined distance may then be compared to a threshold distance (expressed with spatial or temporal quantities) in order to decide the likelihood of entering the indoor location 640.

In a first example embodiment, the checking 118 indicates that the mobile apparatus 200 is likely to enter the indoor location 640, if a determined location 634 of the mobile apparatus 200 is within a predetermined distance 636 from the indoor location 640 for which the indoor signal map data 258 exists. The distance 636 may be estimated by calculating the distance from the determined location 634 to a nearest entrance of the indoor location 640, if the location of the entrance is known, or otherwise the shortest distance 636 to the indoor location 640 may be calculated (in a straight line, or along roads, streets, pavements etc. if their path is known in a map).

In a second example embodiment, the checking 118 indicates that the mobile apparatus 200 is likely to enter the indoor location 640, if a determined location 634 of the mobile apparatus 200 is within a predetermined travel time 636 from the indoor location 640 for which the indoor signal map data 258 exists. For this example embodiment, the location 634 of the mobile apparatus 200 must be determined, and then the distance 636 to the indoor location 640 may be calculated, based on a detected travel speed of the user of the mobile apparatus 200, or based on an average car/pedestrian travel speed, for example. Also direction of the movement of the mobile apparatus 200 may be taken into account in the checking 118: if the mobile apparatus 200 is not coming closer to the indoor location 640, the checking 118 may indicate that the mobile apparatus 200 is not likely to enter the indoor location 640 (at least for now, but it will be checked again after the next triggering by the invoke mechanism 116).

In a third example embodiment illustrated in FIG. 7, the checking 118 indicates that the mobile apparatus 200 is likely to enter the indoor location 640, if a determined location 634 of the mobile apparatus 200 is within a predetermined outdoor zone 700 adjacent to the indoor location 640 for which the indoor signal map data 258 exists. The predetermined outdoor zone 700 may determine an area or a perimeter from which the user of the mobile apparatus 200 typically enters the indoor location 640.

In a fourth example embodiment, the checking 118 indicates that the mobile apparatus 200 is likely to enter the indoor location 640, if a determined location 634 of the mobile apparatus 200 is in predetermined geographical coordinates adjacent to the indoor location 640 for which the indoor signal map data 258 exists, by a predetermined margin 632. The predetermined margin 632 may be the accuracy of the positioning, i.e., the position of the mobile apparatus 200 is within the circle 632.

In a fifth example embodiment, the checking 118 indicates that the mobile apparatus 200 is likely to enter the indoor location 640, if a first location of the mobile apparatus 200 determined by receiving radio signals with a radio transceiver 214, 216 of the mobile apparatus 200 indicates that the mobile apparatus 200 is likely to enter the indoor location 640 for which the indoor signal map data 258 exists, even if a second location of the mobile apparatus 200 determined by receiving global navigation satellite system signals with a satellite receiver 210 of the mobile apparatus 200 indicates something different. This example embodiment is applicable to such a situation, where the GNSS positioning gives a poor result, such as in a location surrounded by skyscrapers, whereas the radio network positioning gives a better result, for example.

Note that if the checking 118 indicates that the mobile apparatus 200 is already in the indoor location 640, then the condition “likely to enter the indoor location 640” is fulfilled in the test 120.

Let us study further example embodiments, which enhance various aspects of the control of the indoor positioning transitions.

In an example embodiment, illustrated in FIG. 7, a transition from an outdoor positioning to the indoor positioning is performed seamlessly, as a determined outdoor location transforms into a determined indoor location, because the generation of the sensor data for the indoor positioning with the one or more sensors 226 is started prior to the mobile apparatus 200 entering the indoor location 640 for which the indoor signal map data 258 exists.

This example embodiment may be implemented as explained, i.e., so that the mobile apparatus 200 is commanded to start the generation of the indoor positioning data with the one or more sensors 226 before the indoor location 640 is entered.

Alternatively, this example embodiments may be implemented as shown in FIG. 7:

First, the mobile apparatus 200 is commanded 710 to start low-accuracy scanning (with a limited set of sensors 226).

As the mobile apparatus enters the vicinity 702 of the indoor location 640, a high-accuracy scanning (with more sensors 226 than in the limited set) is commanded 712. The vicinity 702 may be defined as a suitable area around the indoor location 640 (such as “within 50 meters of the indoor location”).

And finally, as the mobile apparatus is about to enter the indoor location 640, the mobile apparatus 200 is commanded 714 to start scanning with all applicable sensors 226.

Note that FIG. 7 also illustrates than when the user exits the indoor location 640, the mobile apparatus 200 is first commanded 716 to resume the high-accuracy scanning, and, as the mobile apparatus 200 exits the vicinity 720, it is commanded 718 to resume the low-accuracy scanning.

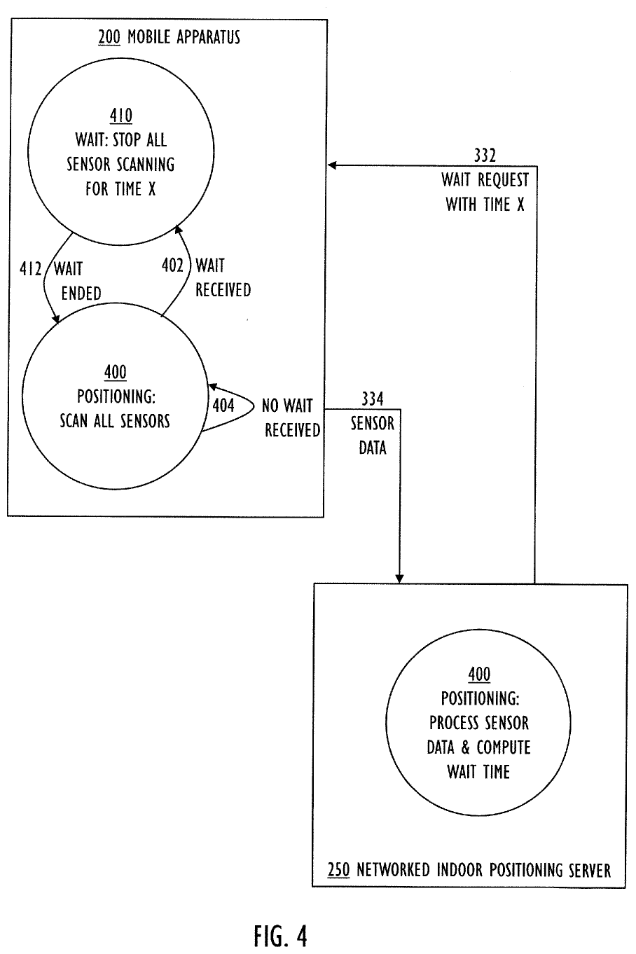

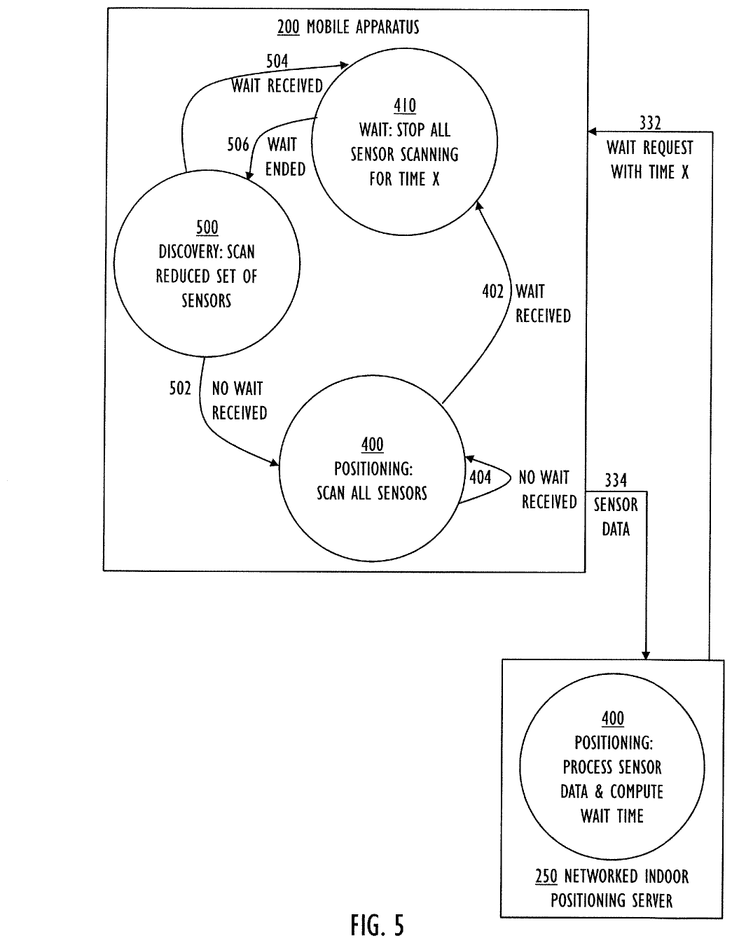

FIGS. 4 and 5 also disclose the difference between the basic example embodiment and the previously mentioned enhanced example embodiment with different levels of scanning.

In both FIGS. 4 and 5, the operating logic of the control apparatus 100 is divided between the mobile apparatus 200 and the networked indoor positioning server 250.

In both cases, the sensor data 334 is transmitted from the mobile apparatus 200 to the server 250, and the server 250 processes the sensor data 334 and computes the wait time, and the wait request with computed wait time x is transmitted 332 to to the mobile apparatus 200.

The difference is that in FIG. 4, there are two states: a wait state 410, where all sensor scanning is stopped for time X, and a positioning state 400, where all sensors are scanned. The state transitions are: no wait received 404, wait received 402 and wait ended 412.

But in FIG. 5, there is an additional discovery state 500, where the reduced set of sensors is scanned, and two additional state transitions: no wait received 502 and wait received 504.

In an example embodiment, the low-accuracy scanning is performed with so-called network platform level (for example: in a cellular radio cell level), the high accuracy scanning with GNSS and radio network positioning, and the all-sensor scanning is performed also with the magnetometer 213 (usable for magnetic indoor positioning) and possibly also with the other sensors of the inertial measurement unit 212.

In an example embodiment illustrated in FIG. 1, during the suspension 114, the mobile apparatus 200 is commanded 112 to disable transmission 113 of the sensor data for the indoor positioning to a networked indoor positioning server 250. This further enhances the power saving. It also relieves the networked indoor positioning server 250 from receiving dummy (or empty) sensor data for the indoor positioning, which brings the advantage of saving data transmission capacity in the network 240 and processing power in the server 250.

In an example embodiment, the mobile apparatus 200 performs an outdoor positioning with one or more of the following: by receiving global navigation satellite system signals with a satellite receiver 210 of the mobile apparatus 200, by receiving radio signals with a radio transceiver 214, 216 of the mobile apparatus 200.

In an example embodiment, the mobile apparatus 200 performs an indoor positioning with one or more of the following: by generating indoor magnetic positioning data with the one or more sensors 226 comprising a magnetometer 213, by receiving indoor radio signals with a radio transceiver 214, 216 of the mobile apparatus 200, by generating inertial measurement data with the one or sensors 226 comprising an inertial measurement unit 212.

Note that the above-described two example embodiments clarify that during the suspension 114 the generation of the sensor data for indoor the positioning with one or more sensors 226 is specifically directed to the magnetometer 213, and/or the radio transceiver(s) 214, 216, and/or the inertial measurement unit 212. During the suspension 114, however, the outdoor positioning may be feasible, and, therefore the satellite receiver 210 and/or the radio transceiver(s) 214, 216 may remain operational. But, if the suspension 114 is caused by the mobile apparatus 200 being in the unmapped indoor location 730, then also the outdoor positioning sensors 210, 214, 216 may be stopped in order to save power.

In an example embodiment, the mobile apparatus 200 performs dead reckoning with the one or sensors 226 comprising an inertial measurement unit 212 in order to provide a basis for the checking of whether the mobile apparatus 200 is likely to enter the indoor location 640 for which the indoor signal map data 258 exists.

Dead reckoning refers to navigation in which a current position of the mobile apparatus 200 is calculated by using a previously determined position, fix, and advancing that position based on a determined speed over elapsed time and course. The speed and the course may be determined with various ways, such as by inertial measurement data (such as acceleration data and/or gyroscope data) produced by the inertial measurement unit 212. If the mobile apparatus 200 is carried around by a pedestrian, pedestrian dead reckoning (PDR) may be used for the construction of the spatial path 740 (as shown in FIG. 7), with all of its finesses (such as the use of step detection, cadence, and direction, all of which may be detected with a pedometer or an acceleration sensor, for example). Also other measurements may be utilized (such as speedometer, milometer and steering direction data provided that the mobile apparatus 200 is coupled with a vehicle). The spatial path 740 may be the determined course or a plurality of determined successive positions. Positions may also be determined with other types of sensor data, with magnetic field data, with radio frequency based positioning utilizing transceivers 214/216 and the so-called triangulation (with reception power information of two or more base stations, for example), for example, and other ways of recognizing a position from among known positions (such as camera-based positioning, for example). The location may be determined with an accuracy that may vary: the known location may be very accurate, within an error margin of a few meters, or less accurate, such as being specific to a certain area (possibly having some radius like 100 meters or less or more, for example).

FIG. 6 illustrates a fast estimation of the distance to a mapped area. This example embodiment utilizes tiles 602, 622. The tiles may be of square shape. The tiles may be formed so that a geographical map is divided into the tiles so that sides of the tiles are defined geographically along the longitudes and the latitudes of the Earth. The tiles may form a hierarchy, whose levels are hereby referred to as zoom levels, such that at any zoom level n, the size 624 of the tiles 622 are smaller than the size 604 of the tiles 602 at the previous zoom level n−1. The distance estimation may be made by, first initializing the distance to a mapped area d to 0 and then looping through zoom levels n_max 610 to n_min 620 so that at each zoom level n:
determine the tile on which the current location is; and
check if the 1-tile neighbourhood of the tile contains a mapped tile -> stop; or
else -> set distance to a mapped area, d, to the diameter of the current tile tilesize (n)-accuracy.

Note that at start of the iteration, the distance d to a mapped area is set to 0.

It will be obvious to a person skilled in the art that, as technology advances, the inventive concept can be implemented in various ways. The invention and its embodiments are not limited to the example embodiments described above but may vary within the scope of the claims.

1. A control apparatus for controlling indoor positioning transitions, comprising:
one or more processors; and
one or more memories storing computer program code, which, when executed by the one or more processors, causes the control apparatus at least:
in response to detecting that a mobile apparatus is in an unmapped indoor or outdoor location, commanding the mobile apparatus to suspend generation of sensor data for indoor positioning with one or more sensors of the mobile apparatus;
in response to an invoke mechanism, checking whether the mobile apparatus is likely to enter an indoor location for which indoor signal map data exists; and
if the checking indicates that the mobile apparatus is likely to enter the indoor location, commanding the mobile apparatus to start generating the sensor data for the indoor positioning with the one or more sensors, or else commanding the mobile apparatus to resume the suspension, and, in response to the invoke mechanism, performing the checking again.

2. (canceled)

3. The control apparatus of claim 1, wherein the suspension of the generation of the sensor data for the indoor positioning with the one more sensors reduces power consumption of the mobile apparatus.

4. The control apparatus of claim 1, wherein the invoke mechanism comprises a timer starting when the suspension is commanded, and after the timer expires, the checking is performed, and if the suspension is resumed, the timer is restarted.

5. The control apparatus of claim 1, wherein the checking indicates that the mobile apparatus is likely to enter the indoor location, if a determined location of the mobile apparatus is within a predetermined distance from the indoor location for which the indoor signal map data exists.

6. The control apparatus of claim 1, wherein the checking indicates that the mobile apparatus is likely to enter the indoor location, if a determined location of the mobile apparatus is within a predetermined travel time from the indoor location for which the indoor signal map data exists.

7. The control apparatus of claim 1, wherein the checking indicates that the mobile apparatus is likely to enter the indoor location, if a determined location of the mobile apparatus is within a predetermined outdoor zone adjacent to the indoor location for which the indoor signal map data exists.

8. The control apparatus of claim 1, wherein the checking indicates that the mobile apparatus is likely to enter the indoor location, if a determined location of the mobile apparatus is in predetermined geographical coordinates adjacent to the indoor location for which the indoor signal map data exists, by a predetermined margin.

9. The control apparatus of claim 1, wherein the checking indicates that the mobile apparatus is likely to enter the indoor location, if a first location of the mobile apparatus determined by receiving radio signals with a radio transceiver of the mobile apparatus indicates that the mobile apparatus is likely to enter the indoor location for which the indoor signal map data exists, even if a second location of the mobile apparatus determined by receiving global navigation satellite system signals with a satellite receiver of the mobile apparatus indicates something different.

10. The control apparatus of claim 1, wherein a transition from an outdoor positioning to the indoor positioning is performed seamlessly, as a determined outdoor location transforms into a determined indoor location, because the generation of the sensor data for the indoor positioning with the one or more sensors is started prior to the mobile apparatus entering the indoor location for which the indoor signal map data exists.

11. The control apparatus of claim 1, wherein during the suspension, the mobile apparatus is commanded to disable transmission of the sensor data for the indoor positioning to a networked indoor positioning server.

12. The control apparatus of claim 1, wherein the mobile apparatus performs an outdoor positioning with one or more of the following: by receiving global navigation satellite system signals with a satellite receiver of the mobile apparatus, by receiving radio signals with a radio transceiver of the mobile apparatus.

13. The control apparatus of claim 1, wherein the mobile apparatus performs an indoor positioning with one or more of the following: by generating indoor magnetic positioning data with the one or more sensors comprising a magnetometer, by receiving indoor radio signals with a radio transceiver of the mobile apparatus, by generating inertial measurement data with the one or sensors comprising an inertial measurement unit, by generating camera data with the one or more sensors comprising a camera.

14. The control apparatus of claim 1, wherein the mobile apparatus performs dead reckoning with the one or sensors comprising an inertial measurement unit in order to provide a basis for the checking of whether the mobile apparatus is likely to enter the indoor location for which the indoor signal map data exists.

15. The control apparatus of claim 1, wherein the mobile apparatus comprises the control apparatus, or a networked indoor positioning server comprises the control apparatus, or functionality of the control apparatus is divided between the mobile apparatus and the networked indoor positioning server.

16. A computer-implemented method for controlling indoor positioning transitions, comprising:
in response to detecting that a mobile apparatus is in an unmapped indoor or outdoor location, commanding the mobile apparatus to suspend generation of sensor data for indoor positioning with one or more sensors of the mobile apparatus;
in response to an invoke mechanism, checking whether the mobile apparatus is likely to enter an indoor location for which indoor signal map data exists; and
if the checking indicates that the mobile apparatus is likely to enter the indoor location, commanding the mobile apparatus to start generating the sensor data for the indoor positioning with the one or more sensors, or else commanding the mobile apparatus to resume the suspension, and, in response to the invoke mechanism, performing the checking again.

17. A non-transitory computer-readable medium comprising computer program code, which, when loaded into one or more processors and executed by the one or more processors, causes performance of a computer-implemented method for controlling indoor positioning transitions, comprising:
in response to detecting that a mobile apparatus is in an unmapped indoor or outdoor location, commanding the mobile apparatus to suspend generation of sensor data for indoor positioning with one or more sensors of the mobile apparatus;
in response to an invoke mechanism, checking whether the mobile apparatus is likely to enter an indoor location for which indoor signal map data exists; and
if the checking indicates that the mobile apparatus is likely to enter the indoor location, commanding the mobile apparatus to start generating the sensor data for the indoor positioning with the one or more sensors, or else commanding the mobile apparatus to resume the suspension, and, in response to the invoke mechanism, performing the checking again.
